(19) United States
(12) Patent Application Publication
(10) Pub. No.: US 2026/0098508 A1
(43) Pub. Date: Apr. 9, 2026

(54) PISTON, INTERNAL COMBUSTION ENGINE, AND VEHICLE

(71) Applicant: Isuzu Motors Limited, Yokohama-shi (JP)

(72) Inventor: Takuro MITA, Fujisawa-shi (JP)

(73) Assignee: Isuzu Motors Limited, Yokohama-shi (JP)

(21) Appl. No.: 19/341,120

(22) Filed: Sep. 26, 2025

(30) Foreign Application Priority Data
Oct. 4, 2024 (JP) 2024-175144

(51) Int. Cl. F02F 3/28

(52) U.S. Cl. CPC F02F 3/28

(57) ABSTRACT

A piston includes a coaxial part and a second land. The coaxial part is formed in a columnar shape or a cylindrical shape. The coaxial part is coaxial with a center axis. Second land is located on one side of a direction along the center axis with respect to the coaxial part. The second land is located such that a center of the second land is displaced toward a thrust side from the center axis.

### CROSS-REFERENCE TO RELATED APPLICATION

This application is based upon and claims the benefit of priority from prior Japanese Patent Application No. 2024-175144, filed Oct. 4, 2024, the entire contents of which are incorporated herein by reference.

### FIELD

The present disclosure relates to a piston, an internal combustion engine, and a vehicle.

### BACKGROUND

An internal combustion engine or the like mounted in a vehicle or the like includes a piston in which a top ring groove is formed (For example, Jpn. Utility Model Appln. Kokoku Publication No. H5-29578). A top ring is disposed in the top ring groove, and the top ring is formed in a C shape including an end gap. Since the top ring rotates relative to the piston, with the center axis of the piston being the rotational axis of the top ring, the position of the end gap around the center axis of the piston varies with time. Blowby gas passes through the end gap, mainly at a compression top dead point or in a period immediately near the compression top dead point at the time of driving of the piston, that is, in a state in which the top ring groove is inclined toward an anti-thrust side.

### SUMMARY

A piston includes a coaxial part and a second land. The coaxial part is formed in a columnar shape or a cylindrical shape. The coaxial part is coaxial with a center axis. Second land is located on one side of a direction along the center axis with respect to the coaxial part. The second land is located such that a center of the second land is displaced toward a thrust side from the center axis.

### BRIEF DESCRIPTION OF THE DRAWINGS

FIG. 1 is a schematic diagram illustrating an example of a structure of a vehicle according to an embodiment.

FIG. 2 is a schematic diagram illustrating an example of a structure of an internal combustion engine according to the embodiment.

FIG. 3 is a cross-sectional view schematically illustrating, by a cross section, an example of a structure of an outer peripheral surface and the vicinity thereof of a piston according to the embodiment.

FIG. 4 is a schematic diagram in a case where in the internal combustion engine according to the embodiment, a structure in the vicinity of an end gap of a top ring is viewed from a cross section that is cut between a top land and an upper surface of the top ring.

FIG. 5 is a schematic diagram in a case where the top land and a second land according to the embodiment are viewed from a bottom side by a cross section that is perpendicular to a center axis of the piston and passes through the second land.

FIG. 6 is a diagram illustrating the internal combustion engine according to the embodiment in a state in which a top ring groove is inclined to an anti-thrust side, compared to a neutral state of the piston.

FIG. 7 is a diagram for describing a spacing distance between the second land and an inner wall surface of a cylinder according to the embodiment.

FIG. 8 is a diagram for describing a spacing distance between a second land and an inner wall surface of a cylinder according to a comparative example.

### DETAILED DESCRIPTION

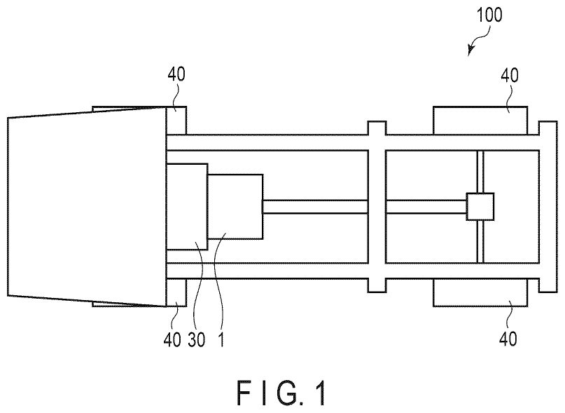

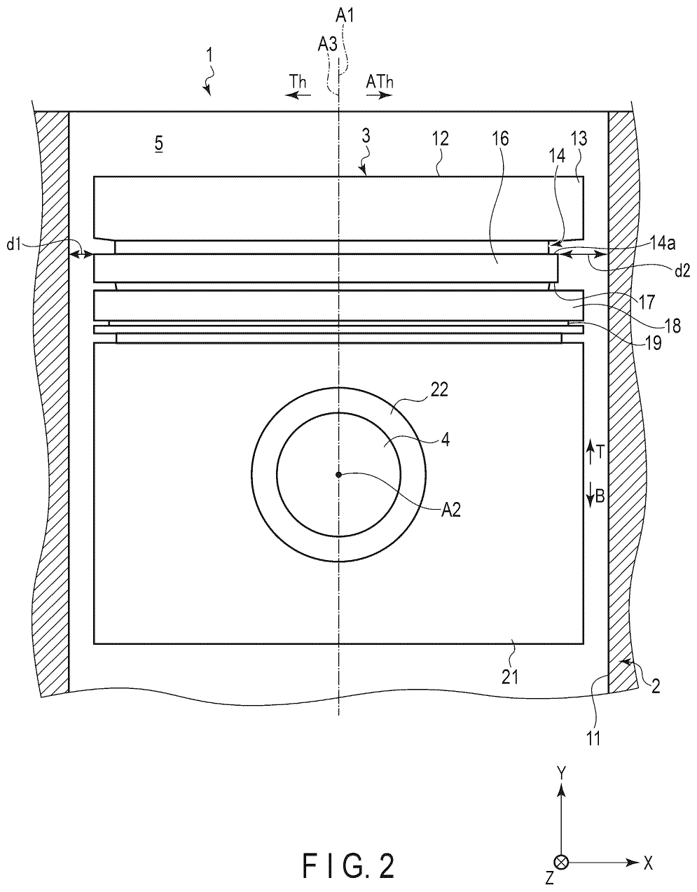

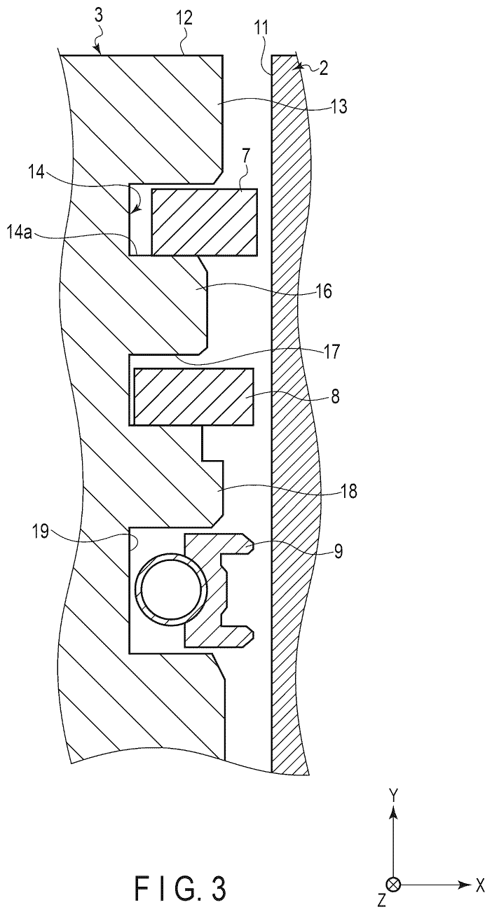

FIG. 1 is a schematic diagram illustrating an example of a structure of a vehicle 100 according to an embodiment. FIG. 2 is a schematic diagram illustrating an example of a structure of an internal combustion engine 1 according to the embodiment. FIG. 3 is a cross-sectional view schematically illustrating, by a cross section, an example of a structure of an outer peripheral surface and the vicinity thereof of a piston 3 according to the embodiment. As illustrated in FIG. 1, the vehicle 100 includes the internal combustion engine 1, a transmission 30, and at least one wheel 40. In the vehicle 100, if the internal combustion engine 1 is driven, driving force is transmitted to at least one wheel 40 via the transmission 30. As illustrated in FIG. 2 and FIG. 3, the internal combustion engine 1 includes a suction valve (not illustrated), a cylinder 2, the piston 3, a piston pin 4, a crank arm (not illustrated), a crank shaft (not illustrated), and a plurality of piston rings. In the internal combustion engine 1, a combustion chamber 5 is formed between the piston 3 and the suction valve. The internal combustion engine 1 according to embodiment is, for example, a 4-stroke engine that constitutes one cycle including four steps of suction, compression, expansion and exhaust. The internal combustion engine 1 according to the embodiment is, for example, a diesel engine. In this case, the piston rings according to the embodiment include a top ring 7, a second ring 8, and an oil ring 9.

The cylinder 2 extends along a center axis A1 and is formed in a cylindrical shape. The cylinder 2 has an inner wall surface 11. In the cylinder 2, an inside space covered by the inner wall surface 11 is formed.

The piston 3 is disposed in the above-described inside space and is coupled to the crank arm via the piston 4 or the like, which extends in a direction perpendicular to the center axis A1 of the cylinder 2. The crank arm is rotatably provided on the crank shaft (not illustrated). Thereby, the piston 3 is reciprocally movable along the center axis A1 of the cylinder 2 in the inside space. In addition, in parallel with the rotation of the crank arm, the piston 3 makes a so-called oscillation movement, by which the piston 3 pivots around a center axis A2 of the piston pin 4 as a pivotal axis.

In the suction step of the internal combustion engine 1, the piston 3 descends toward the crank shaft side with respect to the suction value, and reaches a bottom dead point. In the compression step, the piston 3 ascends toward the suction valve side from the bottom dead point. At the time of driving of the piston 3, a time point at which the piston has completely ascended in the compression step is referred to as a compression top dead point. In addition, at the compression top dead point and in a period immediately near the compression top dead point at the time of driving of the piston 3, fuel supplied in the cylinder 2 is burnt. In the expansion step, the piston 3 descends to the bottom dead point once again. Then, in the exhaust step, the piston 3 ascends once again from the bottom dead point toward the suction valve side. A time point at which the piston 3 has completely ascended in the exhaust step is referred to as an exhaust top dead point. In this manner, in one cycle including four steps of suction, compression, expansion and exhaust, the piston 3 reciprocates twice between the piston position corresponding to the compression top dead point or the exhaust top dead point, and the bottom dead point. The crank arm rotates twice, in accordance with the reciprocal movement of the piston 3 during one cycle. Then, in the suction step after the exhaust step, the piston 3 descends toward the bottom dead point once again. Note that the compression top dead point and the period immediately near the compression top dead point mean a time point at which the compression step changes to the expansion step and a period immediately near this time point. Thus, the exhaust top dead point and the period immediately near the exhaust top dead point are not included in the compression top dead point and the period immediately near the compression top dead point.

Hereinafter, one side of a center axis A3 of the piston 3 is referred to as a top side T, and the opposite side to the top side T is referred to as a bottom size B. In the piston 3, for example, a piston top surface 12, a top land 13, a top ring groove 14, a second land 16, a second ring groove 17, a third land 18, an oil ring groove 19 and a piston skirt 21 are formed in the named order from the top side T. The piston top surface 12 is an end surface on the top side T in the piston 3, and faces toward the top side T. The piston skirt 21 forms an end surface on the bottom side B in the piston 3, and the end surface on the bottom side B that the piston skirt 21 forms faces toward the bottom side B.

The top ring groove 14 is formed of a plurality of surfaces. Of the surfaces forming the top ring groove 14, an end surface on the bottom side B is referred to as a lower surface 14a. The lower surface 14a of the top ring groove 14 extends along a radial direction (to be described later) from an inner peripheral end to an outer peripheral end. A groove may be formed in an outer peripheral surface of the second land 16. The third land 18 is formed in a columnar shape. In the piston skirt 21 of the piston 3, each of a pair of piston pin bosses (not illustrated) projects toward the inner peripheral side. In addition, in the piston skirt 21, a piston pin hole 22, in which the piston pin 4 is inserted, is formed in each of the piston pin bosses. The center axis A2 of the piston pin 4 is coaxial or substantially coaxial with the center axis of the piston pin hole 22.

In the present embodiment, the piston used in the diesel engine, among internal combustion engines, is described as an example, but the piston is not limited to this. The piston may be used in other internal combustion engines such as a gasoline engine, aside from the case where the piston is used in the diesel engine. However, the number of ring grooves formed in the piston varies in accordance with the internal combustion engine in which the piston is used.

Next, in the piston 3, a coaxial part is defined. The center axis of the coaxial part is coaxial with the center axis of the piston 3, and is formed in a columnar shape or a cylindrical shape. The coaxial part is any one of the structures of the piston 3 excluding the second land 16. Specifically, the second land 16 is located on one side in the direction along the center axis A3 of the piston 3 with respect to the coaxial part. The coaxial part is, for example, the piston skirt 21. In this case, the center axis A3 of the piston 3 is coaxial with the center axis of the piston skirt 21. Aside from this, the coaxial part may be, for example, the third land 18. In this case, the center axis A3 of the piston 3 is coaxial with the center axis of the third land 18. In addition, the coaxial part may be, for example, the top land 13. In this case, the center axis A3 of the piston 3 is coaxial with the center axis of the top land 13. Besides, the coaxial part may be a structure other than the top land 13, third land 18 and piston skirt 21 among the structures of the piston 3. Here, the center of a cross section of the piston 3, which is cut by a plane that includes the center axis of the piston pin hole 22 and is perpendicular to the center axis of the top land 13, third land 18 or piston skirt 21, is defined as the center of the piston pin hole 22. In addition, the center axis A3 of the piston 3 may be coaxial with an axis that is perpendicular to the center axis of the piston pin hole 22 and passes through the center of the piston pin hole 22. Note that the cross section illustrated in FIG. 3 is a part of a cross section in a case where the internal combustion engine 1 is cut along a plane that includes the center of the piston pin hole 22 and is perpendicular to the center axis of the piston pin hole 22. Hereinafter, a direction around the center axis A3 of the piston 3 is defined as a circumferential direction, and a direction that is perpendicular to the center axis A3 of the piston 3 and the circumferential direction of the piston 3 is defined as a radial direction.

An inclination angle at a time when the piston 3 is inclined from the state in which the center axis A3 of the piston 3 extends along the center axis A1 of the cylinder 2 is referred to as an oscillation angle θ of the piston 3. FIG. 2 illustrates the piston 3 in the state in which the center axis A3 of the piston 3 is not inclined with respect to the center axis A1 of the cylinder 2 and coincides with the center axis A1 of the cylinder 2. This state of the piston is referred to as a neutral state of the piston.

The piston 3 makes an oscillation movement and receives a lateral pressure from the cylinder 2. In the internal combustion engine 1, a maximum lateral pressure occurs immediately after the compression top dead point. At this time, of the parts of the piston 3, a part formed on the bottom side B with respect to the piston pin hole 22 is inclined toward one side from the neutral state, and a part formed on the top side A with respect to the piston pin hole 22 is inclined toward the other side opposite to the one side from the neutral state. Hereinafter, at the compression top dead point and in the period immediately near the compression top dead point, the side, toward which the part formed on the bottom side B with respect to the piston pin hole 22 is inclined, is referred to as a thrust side Th, and the side, toward which the part formed on the top side T with respect to the piston pin hole 22 is inclined, is referred to as an anti-thrust side ATh. For example, since the top ring groove 14 is the part formed on the top side T with respect to the piston pin hole 22, the top ring groove 14 is inclined toward the anti-thrust side ATh, compared to the neutral state, at the compression top dead point and in the period immediately near the compression top dead point.

Here, in FIG. 2, a direction along the center axis A1 of the cylinder 2 is defined as a Y-axis direction, a direction, which is perpendicular to the Y-axis direction and in which the piston pin 4 extends, is defined as a Z-axis direction, and a direction perpendicular to the Y-axis direction and the Z-axis direction is defined as an X-axis direction. In regard to the X-axis direction, the anti-thrust side ATh is defined as a positive direction of the X-axis direction, and the thrust side Th is defined as a negative direction of the X-axis direction. In addition, the suction valve side is defined as a positive direction of the Y-axis direction, and the crank shaft side is defined as a negative direction of the Y-axis direction. Besides, the depth side with respect to the drawing sheets of FIG. 2 and FIG. 3 is defined as a positive direction of the Z-axis direction, and the near side is defined as a negative direction of the Z-axis direction.

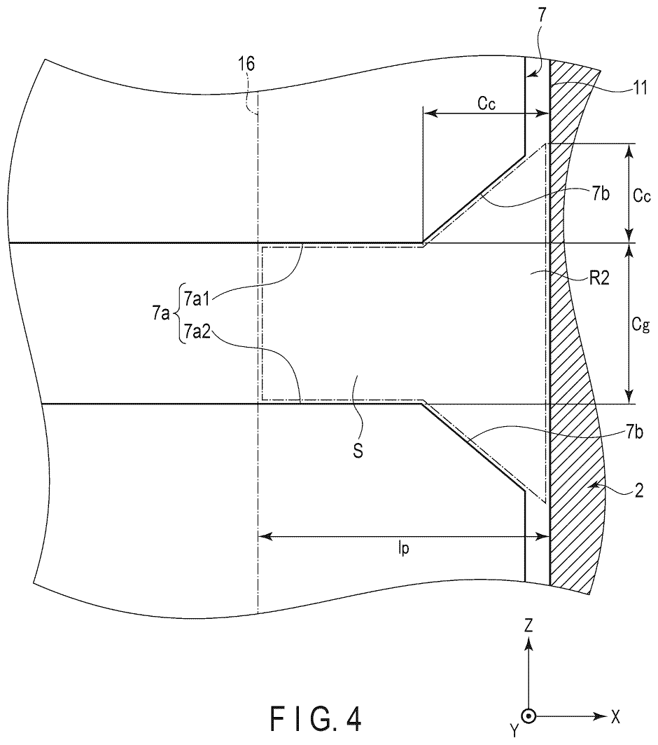

FIG. 4 is a schematic diagram in a case where in the internal combustion engine 1 according to the embodiment, a structure in the vicinity of an end gap S of the top ring 7 is viewed from a cross section that is cut between the top land 13 and an upper surface of the top ring 7. In the top ring groove 14, the top ring 7 is disposed. The top ring 7 includes two end portions 7a, and is formed to extend in a C shape from an end portion 7al on one side to an end portion 7a2 on the other side. The end gap S is formed between the two end portions 7a. The two end portions 7a face each other with the end gap S being interposed. Hereinafter, a spacing distance between the two end portions 7a of the top ring 7 is defined as Cg. In each of the two end portions 7a, a chamfered portion 7b is formed. In the chamfered portion 7b according to the embodiment, for example, a chamfer width Cc along the radial direction of the piston 3 is identical to a chamfer width Cc along the circumferential direction. The top ring 7 rotates relative to the piston 3, with the center axis A3 of the piston 3 being the rotational axis. Thus, the position of the end gap S around the center axis A3 of the piston 3 varies with time.

Here, a spacing distance between a part on the thrust side Th of the outer peripheral surface of the second land 16 and the inner wall surface 11 of the cylinder 2 is referred to as a first spacing distance d1. In addition, a spacing distance between a part on the anti-thrust side ATh of the outer peripheral surface of the second land 16 and the inner wall surface 11 of the cylinder 2 is referred to as a second spacing distance d2. For example, in FIG. 2, the first spacing distance d1 and the second spacing distance d2 in the neutral state are illustrated. As the top ring groove 14 is more inclined toward the anti-thrust side ATh, the part on the thrust side Th of the outer peripheral surface of the second land 16 becomes more distant from the inner wall surface 11 of the cylinder 2, and thus the first spacing distance d1 becomes larger. On the other hand, as the top ring groove 14 is more inclined toward the anti-thrust side ATh, the part on the anti-thrust side ATh of the outer peripheral surface of the second land 16 becomes closer to the inner wall surface 11 of the cylinder 2, and the second spacing distance d2 becomes smaller.

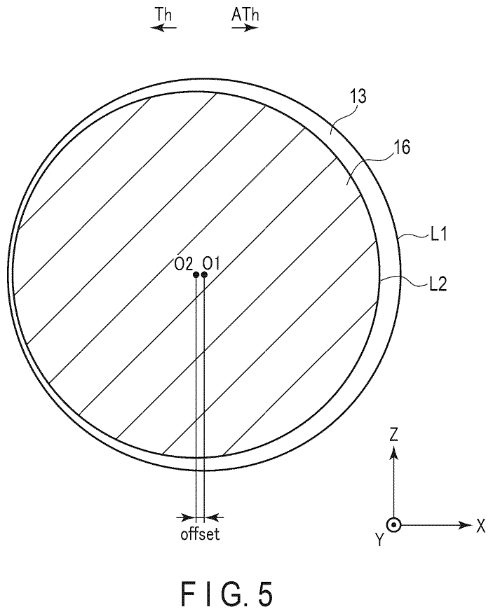

FIG. 5 is a schematic diagram in a case where the top land 13 and the second land 16 according to the embodiment are viewed from the bottom side B by a cross section that is perpendicular to the center axis A3 of the piston 3 and passes through the second land 16. Note that FIG. 5 illustrates a state in which the top ring 7 is not disposed in the top ring groove 14. In addition, FIG. 5 illustrates an example in which the top land 13 is the coaxial part. In FIG. 5, a point O1 represents a point at which the center axis A3 of the piston 3 passes through the top land 13. Since the top land 13 is the coaxial part, the point O1 is the center of the top land 13. In addition, in FIG. 5, a point O2 represents a center O2 of the second land 16. Furthermore, in FIG. 5, a circle L1 represents an outer peripheral surface of the top land 13, and a circle L2 represents an outer peripheral surface of the second land 16. As illustrated in FIG. 5, the center O2 of the second land 16 is located with a displacement toward the thrust side Th from the center axis A3 (point O1) of the piston 3. Thus, in the neutral state illustrated in FIG. 2, the second spacing distance d2 is greater than the first spacing distance d1. Hereinafter, a distance along the radial direction from the center axis A3 of the piston 3 to the center O2 of the second land 16 is referred to as an offset amount “offset”. The center O2 of the second land 16 is located with a displacement of the offset amount “offset” toward the thrust side Th from the center axis A3 of the piston 3.

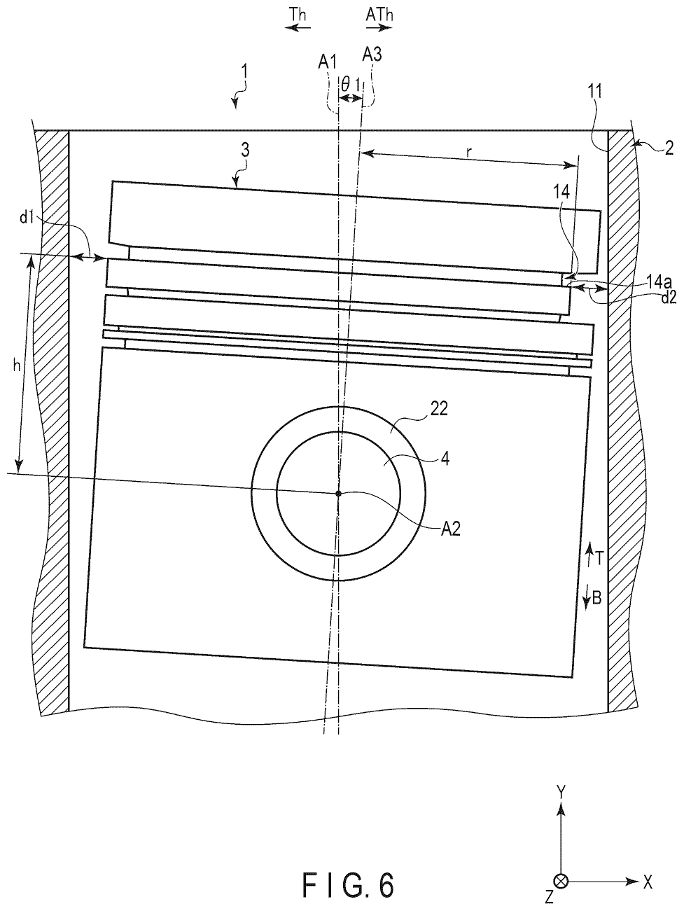

Here, FIG. 6 is a diagram illustrating the internal combustion engine 1 according to the embodiment in a state in which the top ring groove 14 is inclined to the anti-thrust side ATh, compared to the neutral state of the piston 3. In FIG. 6, a set angle θ1 is an angle that is preset at the time of designing the piston 3, and is an angle that is assumed to be an inclination angle of the piston 3 at any one of time points of the compression top dead point and the period immediately near the compression top dead point. The piston 3 illustrated in FIG. 6 is inclined by the set angle θ1 with respect to the center axis A1 of the cylinder 2. Typically, the set angle θ1 is set at a value in a range of 0.05 degree to 0.5 degree. The offset amount “offset” becomes a value based on an outside radius r of the piston 3 at a position of the lower surface 14a of the top ring groove 14, a distance h along the center axis A3 of the piston 3 between the center of the piston pin hole 22 and the lower surface 14a of the top ring groove 14, and the set angle θ1 of the piston 3, which are illustrated in FIG. 6. The outside radius r at the position of the lower surface 14a of the top ring groove 14 corresponds to a distance in the radial direction between the center axis A3 of the piston 3 and the outer peripheral end of the lower surface 14a of the top ring groove 14. Specifically, f(θ1) is calculated as the offset amount “offset”, by substituting the outside radius r, distance h and set angle θ1 in equation (1-A) below.

$$f ( θ ) = \sqrt{{r}^{2} + {h}^{2}} sin \{ {tan}^{- 1} ( \frac{r}{h} ) + θ \} - r \qquad ( 1 - A )$$

The offset amount “offset” becomes, for example, a value in a range of 0.05 mm to 0.5 mm, from the set angle θ1 that is a value in the range of 0.05 degree to 0.5 degree, the outside radius r in a general piston 3, and the distance h. Here, the internal combustion engine 1 in one example is a water-cooling-type, 4-cycle direct-injection-type diesel engine. In this engine, four cylinders are disposed in series. The displacement of this engine is 2999 cc. The inside diameter of the inner wall surface of the cylinder included in this engine is 95.4 mm, and the length of the stroke of the cylinder is 104.9 mm. In the case of mounting this engine in the vehicle 100, the offset amount “offset” is in a range of 0.13 to 0.17 mm.

In addition, among the oscillation angles θ at the compression top dead point and in the period immediately near the compression top dead point at the time of driving of the above-described piston 3, if there is an oscillation angle θ2 that coincides with the set angle θ1, a value obtained by substituting this oscillation angle θ2 in equation (1-A) coincides with the offset amount “offset”. Note that there is a case where among the oscillation angles θ at the compression top dead point and in the period immediately near the compression top dead point at the time of driving of the above-described piston 3, the oscillation angle θ2 that coincides with the set angle θ1 is not present.

Since blowby gas mainly flows, at the compression top dead point and in the period immediately near the compression top dead point, from the combustion chamber 5 to the bottom side B through the end gap S, the end gap S becomes a dominant flow path of the blowby gas. The flow rate of the blowby gas increases as a flow path area A of the end gap S becomes larger. In FIG. 4, a region R2 surrounded by a dash dotted line represents a region where the blowby gas flows in the end gap S, and the area of this region becomes the flow path area A.

Here, a spacing distance between that part of the outer peripheral surface of the second land 16, which neighbors the bottom side B with respect to the end gap S, and the inner wall surface 11 of the cylinder 2 is referred to as an end spacing distance lp. In a case where the end gap S is located on the thrust side Th, the end spacing distance lp can be regarded as coinciding with the first spacing distance d1. In addition, in a case where the end gap S is located on the anti-thrust side ATh, the end spacing distance lp can be regarded as coinciding with the second spacing distance d2. In the neutral state, the second spacing distance d2 is greater than the first spacing distance d1. Thus, the end spacing distance lp is greater in the case where the end gap S is located on the anti-thrust side than in the case where the end gap S is located on the thrust side. In this manner, the magnitude of the end spacing distance lp varies depending on the location where the end gap S is positioned.

Specifically, the flow path area A of the end gap S is calculated, for example, by substituting the end spacing distance lp, a spacing distance Cg between the two end portions 7a of the top ring 7, and the chamfer width Cc in each of the two end portions 7a in equation (2-A) below.

$$A = lpCg + {Cc}^{2} \qquad ( 2 - A )$$

According to equation (2-A), the flow path area A of the end gap S is expressed by a linear function having the end spacing distance lp as a variable. Thus, at a time when the end spacing distance lp takes a maximum value, the flow path area A of the end gap S becomes maximum, and, in a case where the pressures at the front and rear of the end gap are equal, the flow rate of blowby gas becomes maximum. In the neutral state, since the end spacing distance lp becomes maximum at the time when the end gap S is located on the anti-thrust side ATh, the flow rate of blowby gas also becomes maximum.

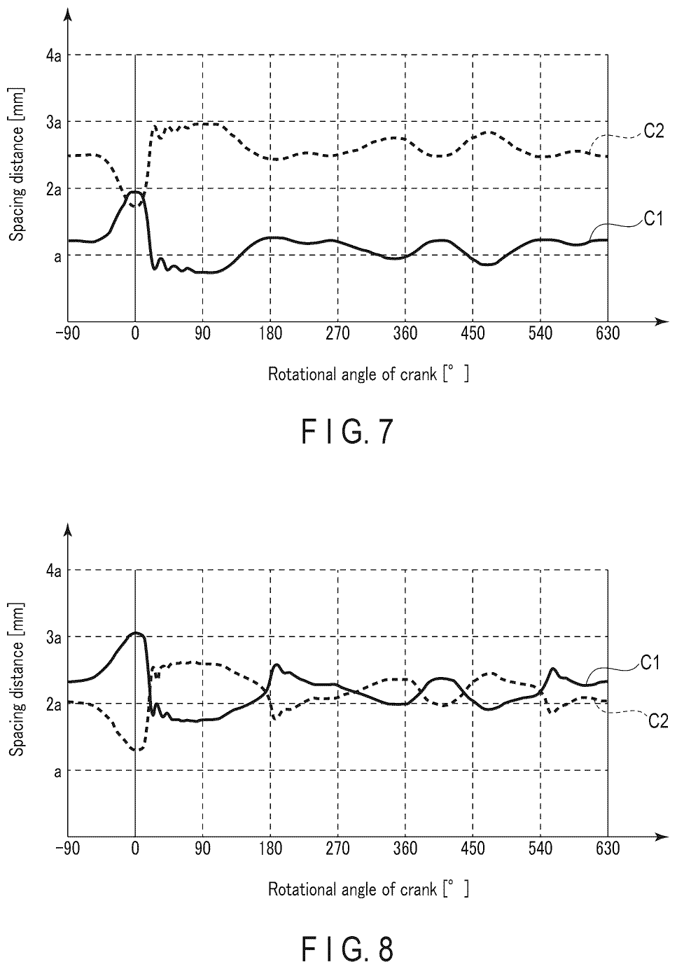

Next, the advantageous effects of the piston 3 constructed as in the above-described embodiment are described with reference to FIG. 7. FIG. 7 is a diagram for describing the spacing distance between the second land 16 and the inner wall surface 11 of the cylinder 2 according to the embodiment. In FIG. 7, the abscissa axis indicates the rotational angle of the crank, and the ordinate axis indicates the spacing distance between the second land 16 and the inner wall surface 11 of the cylinder 2. The rotational angle of the crank is an angle formed by a straight line that extends along the center axis A2 of the cylinder 2 and extends from the crank shaft side toward the suction valve side, and the crank arm extending from one end side coupled to the crank shaft toward the other end side. Symbol “a” indicated near the ordinate axis in FIG. 7 is a predetermined numeral and represents a value of the ordinate axis. In FIG. 7, a curve C1 expressed by a solid line represents the first spacing distance d1 in relation to the rotational angle of the crank, and a curve C2 expressed by a broken line represents the second spacing distance d2 in relation to the rotational angle of the crank. In FIG. 7, in the present embodiment, it is assumed that at a time when the rotational angle of the crank is 0 degree, the piston 3 is at a time point corresponding to the compression top dead point. In addition, the compression top dead point and the period immediately near the compression top dead point mean, for example, a period during which the rotational angle of the crank is in a range of −45 degrees to 45 degrees. Note that the compression top dead point and the period immediately near the compression top dead point may be, for example, a period during which the piston 3 is located on the top dead point side with respect to a position at which the distance from the top dead point and the distance from the bottom dead point are equal, in the compression step or the expansion step. Specifically, the period during which the rotational angle of the crank falls within the range of ±20 degrees centering on the rotational angle at the time point corresponding to the compression top dead point at the time of driving of the piston 3 is set to be the compression top dead point and the period immediately near the compression top dead point.

The center O2 of the second land 16 according to the embodiment is located with a displacement toward the thrust side Th from the center axis A3 of the piston 3. In a case of not the compression top dead point or the period immediately near the compression top dead point, for example, in a case where the rotational angle of the crank is −90 degrees, the top ring groove 14 is not inclined toward the anti-thrust side ATh, compared to the case of the compression top dead point and the period immediately near the compression top dead point. Thus, the second spacing distance d2 is greater than the first spacing distance d1. In addition, as the rotational angle of the crank becomes closer to 0 degree, the top ring groove 14 is inclined toward the anti-thrust side ATh, and thus the first spacing distance d1 becomes larger and the second spacing distance d2 becomes smaller. As illustrated in FIG. 7, at the timing of the compression top dead point, the first spacing distance d1 and the second spacing distance d2 are in a substantially equal level in regard to the difference therebetween. Specifically, for example, on the outside of the compression top dead point and the period immediately near the compression top dead point, the second spacing distance d2 becomes greater than the first spacing distance d1, and at the compression top dead point and in the period immediately near the compression top dead point, the difference between the first spacing distance d1 and the second spacing distance d2 becomes smaller. In addition, at the compression top dead point and in the period immediately near the compression top dead point, there is a case where the first spacing distance d1 becomes greater than the second spacing distance d2. In this case, at any one of time points of the compression top dead point and the period immediately near the compression top dead point, the difference between the first spacing distance d1 and the second spacing distance d2 becomes zero. At this time, the end spacing distance lp in the case where the end gap S is located on the thrust side Th can be regarded as coinciding with the end spacing distance lp in the case where the end gap S is located on the anti-thrust side ATh. At this time, the difference between the flow rate of blowby gas at the time when the end gap S is located on the thrust side Th and the flow rate of blowby gas at the time when the end gap S is located on the anti-thrust side ATh can be regarded as being zero. Note that at the compression top dead point and in the period immediately near the compression top dead point, the difference between the first spacing distance d1 and the second spacing distance d2 becomes smaller, even if not zero, compared to the case of not the compression top dead point or the period immediately near the compression top dead point. Accordingly, at the compression top dead point and in the period immediately near the compression top dead point, the difference between the flow rate of blowby gas at the time when the end gap S is located on the thrust side Th and the flow rate of blowby gas at the time when the end gap S is located on the anti-thrust side ATh becomes smaller, compared to the case of not the compression top dead point or the period immediately near the compression top dead point.

Here, a piston including a second land, the center of which coincides with the center axis of the piston, is described as a comparative example of the structure according to the embodiment. It is assumed that, of the structures of the piston according to the comparative example, the structures other than the structure of the second land are identical to the structures of the piston according to the embodiment. Here, FIG. 8 is a diagram for describing the spacing distance between the second land and the cylinder according to the comparative example. In FIG. 8, like FIG. 7, the abscissa axis indicates the rotational angle of the crank, and the ordinate axis indicates the spacing distance between the second land and the inner wall surface of the cylinder. In addition, in FIG. 8, like FIG. 7, a curve C1 expressed by a solid line represents the first spacing distance in relation to the rotational angle of the crank, and a curve C2 expressed by a broken line represents the second spacing distance in relation to the rotational angle of the crank. Furthermore, in FIG. 8, like FIG. 7, symbol “a” indicated near the ordinate axis is a predetermined numeral and represents a value of the ordinate axis. In the piston according to the comparative example, in the neutral state, the first spacing distance coincides with the second spacing distance. In addition, as illustrated in FIG. 8, the top ring groove 14 is more inclined toward the anti-thrust side, as the rotational angle of the crank becomes closer to, for example, 0 degree from −90 degrees, and thus the first spacing distance becomes larger and the second spacing distance becomes smaller. Thus, as the rotational angle of the crank becomes closer to 0 degree from −90 degrees, the difference between the first spacing distance and the second spacing distance becomes larger.

In addition, the flow rate of blowby gas passing through the end gap formed in the internal combustion engine according to the comparative example, and the flow rate of blowby gas passing through the end gap S formed in the internal combustion engine 1 according to the embodiment, at the compression top dead point and in the period immediately near the compression top dead point, are compared with reference to FIG. 7 and FIG. 8. Hereinafter, a description is given, with attention being paid to the compression top dead point and the period immediately near the compression top dead point. As illustrated in FIG. 8, in the piston according to the comparative example, the first spacing distance is greater than the second spacing distance. In addition, the first spacing distance becomes a maximum value of the end spacing distance whose value varies in accordance with the position of the end gap around the axis, and this value is about 3“a”. On the other hand, as illustrated in FIG. 7, in the piston 3 according to the embodiment, the first spacing distance d1 or the second spacing distance d2 becomes a maximum value of the end spacing distance lp, and the magnitude of these value are about 2“a”. In this manner, the maximum value of the end spacing distance lp in the piston according to the embodiment is smaller than the maximum value of the end spacing distance in the piston according to the comparative example. From the above, the maximum value of the flow rate of blowby gas flowing through the end gap S formed in the internal combustion engine 1 according to the embodiment becomes smaller than the maximum value of the flow rate of blowby gas passing through the end gap formed in the internal combustion engine according to the comparative example. In this manner, the flow rate of blowby gas at the compression top dead point and in the period immediately near the compression top dead point can be optimized. Note that at the compression top dead point and in the period immediately near the compression top dead point at the time of driving of the piston 3 according to the embodiment, there is a case where the difference between the first spacing distance d1 and the second spacing distance d2 does not become zero. Even in this case, the difference between the first spacing distance d1 and the second spacing distance d2 becomes smaller than the difference between the first spacing distance d1 and the second spacing distance d2 at the compression top dead point and in the period immediately near the compression top dead point at the time of driving of the piston 3 according to the comparative example. Thereby, even in this case, at the compression top dead point and in the period immediately near the compression top dead point, the maximum value of the end spacing distance lp in the piston 3 according to the embodiment becomes smaller than the maximum value of the end spacing distance lp in the piston according to the comparative example. Accordingly, the maximum value of the flow rate of blowby gas flowing through the end gap S formed in the internal combustion engine 1 according to the embodiment becomes smaller than the maximum value of the flow rate of blowby gas passing through the end gap formed in the internal combustion engine according to the comparative example.

In addition, compared to the piston according to the comparative example, since the maximum value of the flow rate of blowby gas at the compression top dead point and in the period immediately near the compression top dead point at the time of driving of the piston 3 can be decreased, the pressure of the second land 16 can be reduced. Thus, a pressure difference between the top land 13 and the second land 16 does not easily decrease, and the direction of the resultant force of a plurality of forces acting on the top ring 7 does not easily become a direction toward the top side T of the piston 3, as viewed from the piston 3. Thereby, in the expansion step in the internal combustion engine 1, lifting of the top ring 7 in relation to the lower surface 14a of the top ring groove 14 can be suppressed. In addition, since the top ring 7 does not easily lift in the expansion step, oil does not easily flow into the combustion chamber 5 from between the lower surface 14a of the top ring 7 that has lifted, and the lower surface 14a of the top ring groove 14. In addition, in the piston 3 according to the embodiment, the difference between the flow rate of blowby gas at the time when the end gap S is located on the thrust side Th and the flow rate of blowby gas at the time when the end gap S is located on the anti-thrust side ATh can be reduced to zero or can be made smaller. Thereby, a variation in consumption amount of oil due to the position variation of the end gap S can be suppressed. From the above, the consumption amount of oil can be optimized.

As described above, the flow rate of blowby gas and the consumption amount of oil can be optimized by displacing the center of the second land toward the thrust side Th from the center axis A3 of the piston 3, that is, by providing the offset. Furthermore, thereby, it is possible to appropriately set design parameters, that is, the end gap S of the top ring 7, the dimensions relating to the end gap of the second ring 8, and the volumes of the lands such as the top land 13, second land 16 and third land 18.

Additionally, according to the embodiment, the offset value offset is the value based on the outside radius r of the lower surface 14a of the top ring groove 14, the distance h along the center axis A3 of the piston 3 between the center of the piston pin hole 22 and the lower surface 14a, and the oscillation angle θ at the compression top dead point and in the period immediately near the compression top dead point. In addition, according to the embodiment, the offset amount “offset” is the value based on f(θ2) in the case of substituting in equation (A-1) the outside radius r, the distance h and the oscillation angle θ2 at any one of time points of the compression top dead point and the period immediately near the compression top dead point. Accordingly, in addition to the above-described advantageous effects, since the offset amount “offset” becomes the value based on the outside radius r, distance h and oscillation angle θ2, the flow rate of blowby gas and the consumption amount of oil can more appropriately be optimized.

Additionally, according to the embodiment, the offset amount is a value in the range of 0.05 mm to 0.5 mm. Since the center O2 of the second land is displaced by the offset amount “offset” in the above range, the flow rate of blowby gas and the consumption amount of oil can more appropriately be optimized.

Additionally, according to the embodiment, in addition to the above-described advantageous effects, an internal combustion engine including the piston 3, in which the flow rate of blowby gas and the consumption amount of oil can be optimized, can be provided. Furthermore, the vehicle 100 including the above-described internal combustion engine can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A piston comprising:
a coaxial part of a columnar shape or a cylindrical shape, the coaxial part being coaxial with a center axis; and
a second land located on one side of a direction along the center axis with respect to the coaxial part, the second land being located such that a center of the second land is displaced toward a thrust side from the center axis.

2. The piston of claim 1, wherein the piston includes, as the coaxial part, a piston skirt that is formed on a bottom side with respect to the second land.

3. The piston of claim 1, further comprising:
a top ring groove formed on a top side with respect to the second land; and
a piston skirt formed on a bottom side with respect to the second land, wherein
the top ring groove includes a lower surface that is an end surface on the bottom side,
a piston pin hole is formed in the piston skirt, and
an offset amount of the center of the second land with respect to the center axis is a value based on an outside radius of the lower surface of the top ring groove, a distance along the center axis between a center of the piston pin hole and the lower surface of the top ring groove, and an oscillation angle at a compression top dead-point and in a period immediately near the compression top dead point.

4. The piston of claim 3, wherein in a case where the outside radius is r, the distance is h, and the oscillation angle at any one of time points of the compression top dead point and the period immediately near the compression top dead point is θ, the offset amount is a value based on f(θ) in a case of substituting the outside radius r, the distance h and the oscillation angle θ in equation (A-1).
$$f ( θ ) = \sqrt{{r}^{2} + {h}^{2}} sin \{ {tan}^{- 1} ( \frac{r}{h} ) + θ \} - r \qquad ( A - 1 )$$

5. The piston of claim 1, wherein the offset amount of the center of the second land with respect to the center axis is a value in a range of 0.05 mm to 0.5 mm.

6. An internal combustion engine comprising:
the piston of claim 1; and
a cylinder forming an inside space in which the piston is disposed.

7. A vehicle comprising the internal combustion engine of claim 6.
